(19) United States
(12) Patent Application Publication
(10) Pub. No.: US 2026/0124560 A1
(43) Pub. Date: May 7, 2026

(54) VARIABLE CRIMPED EXPANDED METAL FILTERS, BI-DIRECTIONALLY EXPANDED METAL FILTERS, COMBINATIONS THEREOF AND EXPANDING METHODS FOR MANUFACTURING EXPANDED SHEET METAL

(71) Applicant: ACS Industries, Inc., Lincoln, RI (US)

(72) Inventors: Erich Bittner, Ellingen (DE); Abad Cruz, Monterrey (MX); Karel Sander, Lake Worth Beach, FL (US); Steven Huntsman, Ogden, UT (US)

(73) Assignee: ACS Industries, Inc., Lincoln, RI (US)

(21) Appl. No.: 19/378,818

(22) Filed: Nov. 4, 2025

Related U.S. Application Data
(60) Provisional application No. 63/716,182, filed on Nov. 4, 2024.

(51) Int. Cl. B01D 29/03; B01D 29/31; B01D 35/02

(52) U.S. Cl. CPC B01D 29/036; B01D 29/31; B01D 35/02; B01D 2201/184; B01D 2201/31

(57) ABSTRACT

Light weight and efficient airbag filter devices are made from expanded metal strips. In some embodiments, an expanded metal strip is a bi-directionally expanded metal sheet where the blade alternately comes from the top-down direction as well as from the bottom-up direction, so that one continuous strip of steel can be expanded facing up in one section and then facing down in the next section without cutting or removing the strip from the processing line. In some embodiments, an expanded metal strip may be crimped variably based upon the layer's length. In some embodiments, bi-directional expanding may be combined with variable crimping of the individual sections/layers allowing for a single strip of metal to be both expanded in two directions and crimped layer by layer during a continuous process on one sheet of metal.

### CROSS-REFERENCE TO RELATED APPLICATIONS

This application claims the benefit of U.S. Provisional Patent Application No. 63/716,182, filed Nov. 4, 2024, the entire contents of which is incorporated herein by reference.

### BACKGROUND OF THE DISCLOSURE

### (1) Field of the Invention

The instant invention relates to rolled or wrapped expanded metal filters, and in particular, rolled or wrapped expanded metal filters for use in airbag inflator assemblies.

### (2) Description of Related Art

Expanded Metal: Expanded metal has found a variety of uses, from mats used for fighting fires to filters for airbag inflators. Expanded metal can be made in a variety of ways. For example, expanded metal can be made by taking a sheet of metal, puncturing the sheet to produce a multiplicity of slits, and pulling the sheet perpendicular to the direction of the slit to elongate the slit and provide an opening in the sheet.

Another more common method for making expanded metal is by piercing and cold forming openings, which are often called “diamonds” because of their final shape. The final length of the sheet, with the accompanying holes, is longer than the original and so it is expanded, as well as the openings formed being expanded. Thus, although the details will vary depending on the specific process, expanded metal sheets are typically made by using a row of teeth or bits in a punch to produce perforations in the sheet. The side of the sheet facing the punch (smooth side) will have an indentation around the perforation, and the reverse side of the sheet (rough side) will have a corresponding raised portion, a burr, around the perforation.

In some cases, the expanded metal is then flattened to reduce the height of the burrs for various reasons.

Expanded metal is well known for use in pyrotechnic airbag inflators as a filter which can both absorb heat and capture slag, cleaning and cooling the explosive airflow before it reaches the air bag. A “Jet Fire” is a turbulent thermodynamic diffusion flame or premixed flame, and results from the combustion of an oxidized fuel (solid or liquid) burning under pressure, and released with significant momentum into a particular direction near to, or above Mach velocity speeds, loaded with burning particulate filled fuel at temperatures normally exceeding 1300° C. This is normally how pyrotechnic airbag inflator systems are designed to function.

As noted above, rolled expanded metal filters are known in the art for cooling the combustion gases and filtering slag particles from a jet fire combustion. The present disclosure relates to an improved filter, an improved manufacturing method of the expanded metal and aspects of wrapping the layers of the filter in such a system.

### SUMMARY OF THE DISCLOSURE

According to exemplary embodiments of the invention, light weight and efficient airbag filter devices are made from expanded metal strips having novel bi-directionally expanded metal and/or variably crimped expanded metal sections (layers) which more effectively encapsulate, cool and filter a jet fire and thus mitigate the flames and burning particles (slag) from escaping the airbag system, where a jet fire is by design propagable inside the filter cavity system.

In some embodiments, an expanded metal strip is a bi-directionally expanded metal sheet where the blade alternately comes from the top-down direction as well as from the bottom-up direction, so that one continuous strip of steel can be expanded facing up in one section and then facing down in the next section without cutting or removing the strip from the processing line.

A rotatable expanding head is disclosed for rotating the expanding blade and fixed die 180 degrees about the strip to change the expanding direction for selected sections/layers of the filter.

In some embodiments, an expanded metal strip may be crimped based upon the layer's length and layered position in the filter.

In some embodiments, bi-directional expanding may be combined with variable crimping of the individual sections/layers allowing for a single strip of metal to be both expanded in two directions and crimped section by section or in alternating sections during a continuous process on one sheet of metal.

While embodiments of the invention have been described as having the features recited, it is understood that various combinations of such features are also encompassed by particular embodiments of the invention and that the scope of the invention is limited by the claims and not the description.

### BRIEF DESCRIPTION OF THE DRAWING FIGURES

While the specification concludes with claims particularly pointing out and distinctly claiming particular embodiments of the instant invention, various embodiments of the invention can be more readily understood and appreciated from the following descriptions of various embodiments of the invention when read in conjunction with the accompanying drawings in which:

FIG. 1 is a perspective view of an exemplary airbag filter formed from a continuous strip of bi-directionally expanded metal in accordance with the teachings of the present disclosure;

FIG. 2 is a plan view of an exemplary bi-directionally expanded metal strip having three sections;

FIG. 3 is a side view thereof showing the smooth side up and smooth side down surfaces on the adjacent sections;

FIG. 4 is an illustration of an exemplary top-down expanding head configuration;

FIG. 5 is an illustration of an exemplary bottom-up expanding head configuration;

FIGS. 6A and 6B are illustrations of a rotatable bi-directional expanding head that is able to retract the expanding blade and die and rotate 180 degrees to reverse the expanding direction from top to bottom and vice versa without having to remove the continuous strip from the production line;

FIG. 7 is a perspective view of an exemplary airbag filter (with no center cavity) formed from a continuous strip of variably crimped expanded metal in accordance with the teachings of the present disclosure;

FIG. 8 is a plan view of an exemplary variably crimped expanded metal strip having three crimped sections separated by two un-crimped sections;

FIG. 9 is an enlarged side view showing the transition from an un-crimped section to a crimped section;

FIG. 10 is a perspective view of an exemplary airbag filter (with center cavity) formed from a continuous strip of variably crimped expanded metal in accordance with the teachings of the present disclosure;

FIG. 11 is a plan view of an exemplary variably crimped expanded metal strip having inner and outer crimped sections separated by a center un-crimped section; and

FIG. 12 is a side view showing the transitions from the inner and outer crimped sections to the central un-crimped section.

### DETAILED DESCRIPTION OF EXEMPLARY EMBODIMENTS

Certain exemplary embodiments will now be described to provide an overall understanding of the principles of the structure, function, manufacture, and use of the device and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present disclosure. Further, in the present disclosure, like-numbered components of the embodiments generally have similar features, and thus within a particular embodiment each feature of each like-numbered component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Further, to the extent that directional terms like top, bottom, up, or down are used, they are not intended to limit the systems, devices, and methods disclosed herein. A person skilled in the art will recognize that these terms are merely relative to the system and device being discussed and are not universal.

This disclosure generally relates to light weight, and more highly efficient, mechanical filtering devices made from expanded metals, such as Directional Flowing Expanded Metals (DFEM), Straight Expanded Metal (SEM) or Variable Expanded Metal (VEM).

More specifically, embodiments of the invention may comprise light weight and efficient airbag filter devices that are made from expanded metal strips having novel bi-directionally expanded and/or variably crimped sections (layers) which more effectively encapsulate, cool and filter a jet fire and thus mitigate the flames and burning particles (slag) from escaping the airbag system, where a jet fire is by design propagable inside the filter cavity system.

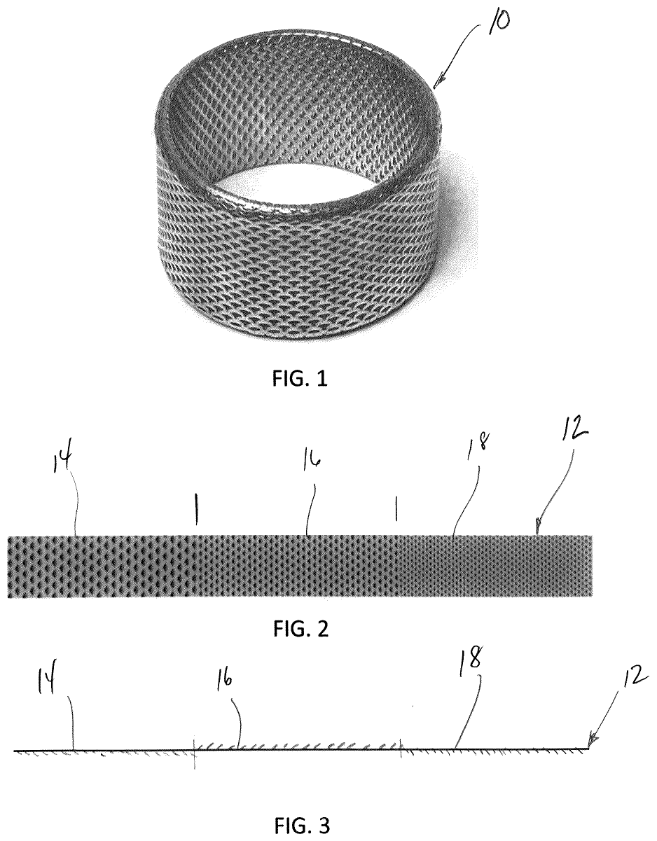

In some embodiments as illustrated in FIGS. 1-3, an airbag filter 10 is formed from a continuous expanded metal strip 12 that is bi-directionally expanded metal where the expanding blade alternately comes from the top-down direction as well as from the bottom-up direction, so that the one continuous strip of steel can be expanded facing up in one section and then facing down in the next section without cutting or removing the strip from the processing line.

FIG. 2 shows a plan view of the exemplary bi-directionally expanded metal strip 12 having three alternating sections (top-down) 14, (bottom-up) 16, (top-down) 18 which are used to form the filter 10 in FIG. 1.

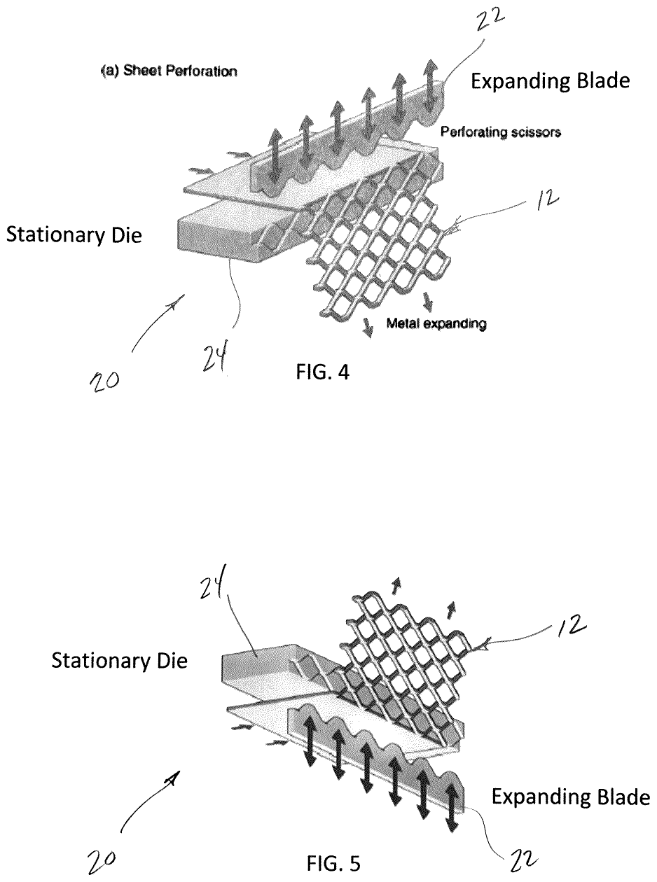

FIG. 3 is a side view of the strip 12 showing the smooth side up (top-down expanding) and smooth side down (bottom-up) expanding surfaces on the adjacent expanded sections. In FIGS. 4-6, a rotatable expanding head assembly 20 is disclosed for rotating an expanding blade 22 and its associated fixed die 24 180 degrees about the strip 12 to change the expanding direction for selected layers of the filter.

The current method for expanding metal sheets is to expand uni-directionally, normally top down, where a standard expanding blade is cyclically pushed through a continuous roll or strip of steel sheet, where teeth on the blade both simultaneously cut rows of slits and then expand the slits to create an expanded row of holes in the sheet with no drop, or no scrap. In order to create a bi-directionally expanded strip, the strip would need to be removed or flipped overt and reset into the production line in reverse. Alternatively, the strips would be cut, flipped and welded together to create a desired configuration.

Accordingly, the present disclosure also relates to a method of manufacturing the continuous expanded metal strip and filter. The present invention relates to a continuous bi-directional expanding method where the blade 22 comes from the top-down direction as well as the opposite direction: from the bottom up, so that one sheet of steel can be expanded so the expanded holes and burrs are expanded facing up in one layer of the strip and facing down in another layer, or layer/wrap of the filter. In one-directional based expanding from the top, the rough (burr) side of the expanded metal faces down and the smooth side faces up. With bi-directional expanding, each layer of the filter 10 can be smooth side up followed by smooth side down, and vice versa.

Bi-directional expanding of one continuous sheet avoids the necessary requirement to flip over the individual sheets of expanded metal 180 degree. Further, the invention avoids the welding or fastening of separate individual pieces of expanded metal together since the expanding equipment has been designed to change expanding directions on the fly.

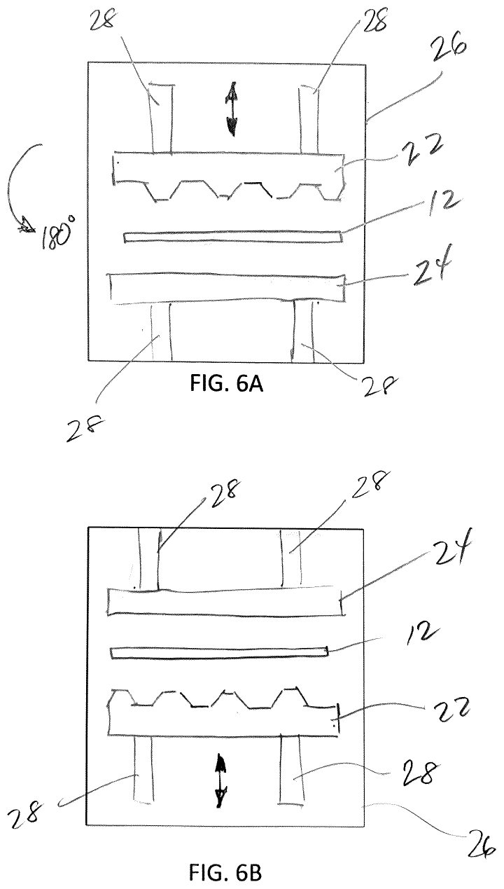

Referring to FIGS. 6A-6B, the top blade and bottom die are mounted in a frame 26 that is rotatable 180 degrees so that the expanding top blade 22 and matching bottom support die 24 can be simultaneously rotated facing the opposite directions (See FIG. 6A top-down and FIG. 6B bottom-up). The expanding blade 22 and die 24 are mounted on linear actuators 28 within the frame 26 to retract the blade 22 and die 24 and allow the head 20 to rotate about the strip 12.

As will be more fully explained below, this bi-directional expanding may be further combined with a downstream variable crimping of the individual layers to allows for a single sheet of metal to be both expanded in two directions and separately crimped layer by layer (section by section) during a continuous process on one sheet or strop of metal.

In some embodiments, one continuous sheet or strip of metal, having a thickness in the range of about 0.05 mm to 1.5 mm in base thickness before expanding, may be made with a directional flowing DFEM blade or other expanded metal pattern (e.g. SEM or VEM), into its final shape of an expanded metal sheet 12.

In some embodiments, the expanded metal strip 12 may then further be variable crimped in order to create alternating flow profiles, for the mixing inside the jet fire filter, by creating diffuser flow profile layers, combined with nozzle flow profile layers via the combining crimping and hole size changes, which are then adjusted on an alternating, and or gradient flow profile basis, on an as-needed design, layer by layer; with all layers in the device being made from the same single sheet of the expanded metal section of the filter device. The as-needed design of the layers is based upon the jet fire gas generate chemical makeup. For example, larger particles in the gas generate makeup may need larger open area than a gas generate with makeup made with smaller particles.

In some embodiments, an expanded metal strip may be crimped based upon the layer's length and layered position in the filter. Crimping may also be utilized with convention uni-directional expanded metal, or as described below may be combined with bidirectionally expanded metal strips to achieve even further improvements in cooling and slag capture.

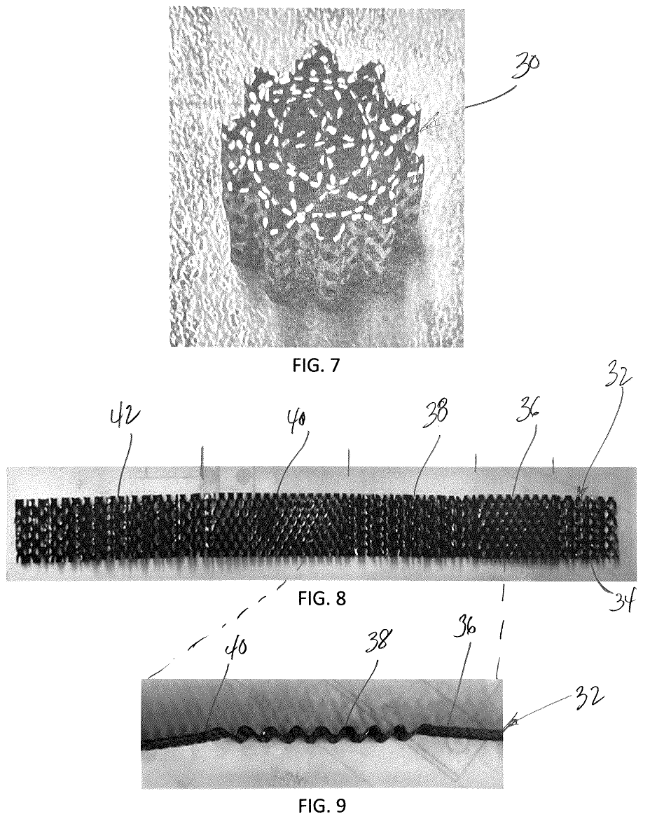

Referring now to FIGS. 7-12, in some embodiments, bi-directional expanding may be combined with variable crimping of the individual sections/layers allowing for a single strip of metal to be both expanded in two directions and crimped layer by layer or in alternating layers during a continuous process on one sheet of metal.

Filters without a Center Hole.

Referring to FIGS. 7-9, some inflator systems direct gas flow from top to bottom of the filter where the filter does not have a central cavity. FIG. 7 is a perspective view of an exemplary airbag filter 30 (with no center cavity) formed from a continuous strip of variably crimped expanded metal 32 in accordance with the teachings of the present disclosure. FIG. 8 is a plan view of the exemplary variably crimped expanded metal strip 32 having three crimped sections 34, 38 and 42 separated by two un-crimped sections 36 and 40. FIG. 9 is an enlarged side view showing the transition from an un-crimped section 36 to a crimped section 38.

The goal is to crimp layers alternatingly, in order to create a alternating flow profile starts with a large total OA (Open Area) within the first layer, not exceeding 60% of the total sheets OA per layer, and then going down in total OA, after the first layer by not crimping them, in order to better cool and collect jet-fire particles using nozzle layers, followed next by crimped diffuser layers. Alternating crimping and no crimping to match the desired gradient slagging and cooling profile of the jet fire fuel chemistry in order to obtain a cleaner and cooler exiting gas temperature.

Filters with a Hole in the Center.

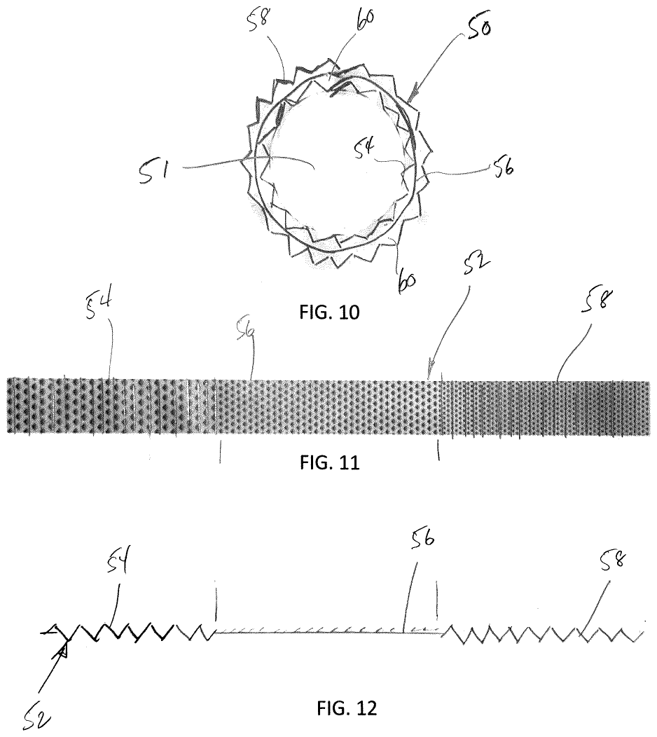

Referring to FIGS. 10-12, many air bag inflator systems are designed with a central cavity in which the explosive propellant is located. FIG. 10 is a perspective view of an exemplary airbag filter 50 (with center cavity 51) formed from a continuous strip of variably crimped expanded metal 52 in accordance with the teachings of the present disclosure. FIG. 11 is a plan view of the exemplary variably crimped expanded metal strip 52 having inner and outer crimped sections 54, 58 separated by a center un-crimped section 56. FIG. 12 is a side view showing the transitions from the inner and outer crimped sections 54, 58 to the central un-crimped section 56.

The goal is to create nozzle and diffuser layers inside a rolled-up filter. The crimped layers alternate to create a gradient flow profile which can start with a large total OA (Open Area) within the first internal layers (Section 54), not exceeding 60% of the total sheets OA per layer, and then going down in total OA, after the first layer by not crimping them, in order to better cool and collect slag filled jet-fire particles using nozzle layers, followed next by crimped diffuser layers. Alternating crimping and no crimping to match the desired gradient slagging and cooling profile of the jet fire fuel chemistry in order to obtain a cleaner and cooler exit gas temperature and exit gas cleanliness.

A further goal is to create a filter that allows for both axial and radial flowing slag filled gases. By design the gases can enter the axial flow direction (normally the top or bottom of the filter) and exit the radial flow direction (circumference) or vice versa and become cleaned and cooler as they exit the system.

An alternating gradient profile is used for the purpose of not prematurely plugging the device (creating excess internal combustion backpressure), and to filter out, by rapid cooling of the larger burning particles in the layers, followed up by smaller particles being captured by the next matting layer, alternating layer by layer using a predetermined profile design as is needed to fill the volume of the filter. Using this method the entire end surface area of the filter ends can be used to spread out the axial flowing gas across the whole end faces.

The most efficient energy transfer or cooling of gas is accomplished near Mach speed (high velocity gas), thus the optimized profile of this device is such that the larger phase changing particles are removed in the large crimped areas of the filter, with slower gas velocities (large OA) in those layers followed in the filter by non-crimped nozzle layers, that help to plate out and remove the cooling metal filled slags finer particles.

As the layers change to smaller total OA inside the device, the flowing gas speed is able to better accelerate, that is once the gas is cleaned of the larger particles. This alternating gradient layer profile more efficiently allows for the velocity of the gas to increase and thermodynamically diffuse the heat with the faster, near Mach gas velocities, in the respective nozzle or orifice layers. The alternating crimped layers and non-crimped layers creates radial flow turbulence of chaotic eddies in the plenum between the layers created by the crimped layers, which will enhance convective heat transfer and particle capture. This layer periodic crimp in the filter allows for a massive Open Area surface area, to be spread out over the entire ID to OD circumference face of the filter to optimize the filtering of the gas.

The in-between layer plenum 60 created by alternating crimping and non-crimping also effectively eliminates the harmful nesting effect of conventional wrapped straight expanded metal filter without crimping.

The single sheet of expanded metal 52 with its alternating crimped and non-crimped profile is wrapped into a round cylindrical shape, which can be spot welded if needed, so that the length of each layer or section length per layer, ends up creating a alternating flow profile, or nozzle funnel shape, starting with large OA, and going smaller in-between the layers.

The outer wrap of this mechanical filtering device can be wrapped with a crimp layer, or another diffuser layer or a mesh layer that does not block the flow inside of the pressurized vessel. The maximum amount of open flow area on the OD is achieved with this design. The gas flow is normally from ID to OD in this system. The mechanical filtering device fits into a pressure vessel which is designed to hold a minimal amount of pressure 7 KPA to 100 KPA (1 psi to 20 psi) which pressure is typically accomplished with the use of a metal burst foil.

When needed, a groove along the circumference of OD can be made at the position corresponding to the diffusing holes of the pressure vessel to allow even and free pathway of flow to the pressure vessel's diffusing holes. Such groove can be pre-formed before wrapping the single sheet of expanded metal into a filter, by adding a void and/or hump on the teeth of the crimping rolls.

The crimping line can be other than vertical (i.e. not 90 degrees), i.e., different from the examples shown in FIGS. 7-12, it can be angled between 15 degrees to 90 degrees. The angle of the crimping line can be optimized for filtering and cooling axial flow in the way to prevent gas from flowing straight through axially from one end of the filter device to the other end of it.

The alternating pattern of crimping and non-crimping can include:
crimping every other layer and non-crimping every other layer; or
crimping one or more layers then non-crimping one or more layers; or
any combination of these.

Applications for this variable crimped expanded metal cooling device invention include airbag inflator filters, which systems rely by design on oxidizers premixed into the solid propellant of gas generating fuel; as a safety device used in vehicle airbags, where a proactive purpose liquid Jet Fire diffusion flame will start during a vehicle crash to protect the occupant from injury by deploying an airbag cushion.

The invention provides optimized cooling of more axial flowing jet fire flames by using crimped layers of a filter alternating with non-crimped layers to faster cool flames and capture particles. The alternating layers of the profile in this device's layers brings more efficient thermodynamic heat transfer for cooling to help the system remove device weight and increase internal plenum space inside a heat transfer filter when a slag filled generate is used.

The weight savings by using a alternating crimped profile of expanded metal combined with non-crimped layers allows for axial flow direction changing of the gas flow direction to radial flow direction, and vice versa, to spread out the slag better along both the diffuser as well as the nozzle layers, using smaller holes to becomes paramount to the smaller weight and cost savings of the device with its main body single sheet construction. In fact, this device's massive internal open flow plenums located in between each layer takes out a massive amount of weight thus lowering the cost of the pressure vessels to save both cost and weight, not only with the crimped expanded metal device, but also with the pressure vessels hardware size and weight, which is the larger saving. Gas may also flow completely axial and never change to radial and still cool better than normal wire mesh filters.

Variable crimped expanded metal may be effective for better cleaning and cooling of the slag filled burning gas. The key to unlocking the optimized designing of lighter weight smaller filters in this invention is the flow profile with alternating crimped and not-crimped layers, using a single metal sheet not welded. Because this invention allows for the preplanning of burning debris particle sizes, by using alternating gradient flow, the device can better plate out the burning fuel, which also places less stress on the device.

The present device can also better use DFEM (Direction Flow Expanded Metal) to help turn the gas a further 90 degrees inside each individual layer of the filter. By using DFEM when needed, it better helps to rotate the flow direction of the gas 90 degrees from the axial or the radial input direction.

The present device can also better use SEM (Straight Expanded Metal) to help eliminate the nesting effect associated with conventional SEM filters.

The variable crimping of layers within one single sheet of Straight Expand Metal (SEM) or DFEM or VEM (Variable Expanded Metal), thus results in lower cost and mistake proofing of the filter by changing the section lengths inside the later rolled up filter of multiple layers; to create a lighter filter at a lower total cost. Therefore, the device can be made with multiple alternating layers to reduce weight and open flow as needed, leading to better cooling level efficiency, and faster mitigation of burning debris ending up in 90 degree or more flow angle gas direction changes, by using an order of magnitude more internal plenum open flow areas inside every other layer, vs. traditional cooling and jet-fire cleaning devices.

Referring now to the drawing Figures,

### EXAMPLES

Variable Crimped Expanded Metal (VCEM) relies on simultaneously slit and stretched expanded metal openings in the metal, to be crimped or not on every matting layer from a single sheet of metal, which openings can, if wanted, also be thus altered on every layer of the filter by the expander controller as a direct result of the expander servo controls, following the software's optimized algorithm flow profile template combined with a closed loop feedback-controlled vision system.

A single expanded strip with alternating crimped layers is then wrapped into a filter with or without an ID open circle. The result being, these crimped slit openings provide better optimized airway flow paths by using more internal plenum flow layers to allow axial or radial flowing gas plenum slag plating, based upon the fuel particle sizes and gas flow direction, or specifically better Phase Changing (liquid matter changing to solid matter via cooling, and the subsequent plating out of slag, due to faster less pressurized thermodynamic energy transfer of optimal dynamic fluid cooling) of the solid or liquid burning molten matter. The key with this invention is to improve spreading out of the incoming slag filled gas area across the entire flat surface ends of the filter, which slit openings by layer are designed to better remove the fluid particles from the rapidly flowing gas, which dynamic energy transfer happens in only a few milliseconds.

OUTER LAYER. The outer layer may be crimped. The advantages include better gas flow plenum outside the expanded metal layers. The outer layer thus provides a mechanical benefit because the layer does not collapse even under extreme loading conditions or upper limit deployment load limit conditions. The outer crimp simply allows gas flow outside the device even if the device loses all hoop strength and presses against the outer pressure vessel (airbag inflator) diffuser metal housing or bonded seal foil. Thus, this outer crimp layer provides a safer live Jet Fire burn, under all temperature conditions (hot, cold, and ambient), better meeting the safety factor standards required by the rigorous industry testing. In short, a properly designed VCEM provides a lower internal combustion pressure footprint, and allows less stress on the vessel's housing, and thus a higher safety factor for less total weight and cost.

Alternating the crimping combines the optimized mixture of a profile design tailored to specific fuel grain sizes, and slagging of the different fuel formulas across the entire filter. The device must separate the generate particles in only a few milliseconds time while cooling the gas down a few hundred degrees in that same time. Thus, each two combined layers of the device with crimped followed by no-crimp of the device's openings are sized better and more efficiently using variable crimping methods (alternating the strip's section length to match the filters diameter changes), so as to not too aggressively hamper a debris flame filled gas flow and over pressurize the vessel (and to keep internal combustion pressures lower). The device can accomplish this once the burning particles are better spread out and removed quickly by creating finer/smaller holes after the crimped layer holes (more flow path surface area) which can be added into the layers to filter smaller and then even smaller airborne particles more quickly via one optimized tortured flow path.

Various additional examples of aspects of the disclosure are described below as numbered paragraphs. These are provided as examples only and do not limit the subject technology.
Aspect 1. A filter for an airbag inflator comprising a continuous strip of expanded metal rolled-up about a longitudinal axis to form multiple rolled, overlapping layers, the filter having an inner layer and a plurality of outer layers, wherein each successive layer of the filter is formed by a discrete section of the continuous strip, wherein the continuous strip is bi-directionally expanded such that at least one section is expanded in a top-down direction providing said section with a smooth side on one surface thereof and at least one section is expanded in a bottom-up direction providing said section with a smooth side on an opposing surface, thereby creating a rolled filter with at least one layer having a smooth side facing inwardly and at least one layer having a smooth side facing outwardly.
Aspect 2. A bidirectionally expanded filter further to aspect 1 wherein the strip of extended metal is flattened.
Aspect 3. A bidirectionally expanded filter further to aspect 1 wherein the top-down and bottom up bi-directionally expanded sections are adjacent to each other.
Aspect 4. A bidirectionally expanded filter further to aspect 1 wherein each layer of said filter comprises a plurality of apertures having an average open area (OA), and wherein the OA's decrease from the inner layer to at least one of the outer layers.
Aspect 5. A bidirectionally expanded filter further to aspect 1 wherein the expanded metal is directional flow expanded metal.
Aspect 6. A bidirectionally expanded filter further to aspect 1 wherein at least one of the sections of the bi-directionally expanded continuous strip is crimped to create a plenum layer.
Aspect 7. A bidirectionally expanded filter further to aspect 1 wherein the continuous strip comprises alternating crimped and non-crimped layers.
Aspect 8. A bidirectionally expanded filter further to aspect 1 wherein the outer layer of the filter is a crimped layer.
Aspect 9. A bidirectionally expanded filter further to aspect 1 wherein the inner layer of the filter is a crimped layer.
Aspect 10. A bidirectionally expanded filter further to aspect 1 wherein the filter has a central cavity.
Aspect 11. A filter for an airbag inflator comprising a continuous strip of expanded metal rolled-up about a longitudinal axis to form multiple rolled, overlapping layers, the filter having an inner layer and a plurality of outer layers, wherein each successive layer of the filter is formed by a discrete section of the continuous strip, wherein at least one of the sections of the continuous strip is crimped to create a plenum layer.
Aspect 12. A variably crimped filter further to aspect 11 wherein the continuous strip comprises alternating crimped and non-crimped layers.

Aspect 13. A variably crimped filter further to aspect 11 wherein the outer layer of the filter is a crimped layer.

Aspect 14. A variably crimped filter further to aspect 11 wherein the inner layer of the filter is a crimped layer.

Aspect 15. A variably crimped filter further to aspect 11 wherein the variably crimped continuous strip is bi-directionally expanded such that at least one section is expanded in a top-down direction providing said section with a smooth side on one surface thereof and at least one section is expanded in a bottom-up direction providing said section with a smooth side on an opposing surface, thereby creating a rolled filter with at least one layer having a smooth side facing inwardly and at least one layer having a smooth side facing outwardly.

Aspect 16. A variably crimpled filter further to aspect 11 wherein the strip of extended metal is flattened.

Aspect 17. A variably crimped filter further to aspect 11 wherein the top-down and bottom up bi-directionally expanded sections are adjacent to each other.

Aspect 18. A variably crimped filter further to aspect 11 wherein each layer of said filter comprises a plurality of apertures having an average open area (OA), and wherein the OA's decrease from the inner layer to at least one of the outer layers.

Aspect 19. A variably crimped filter further to aspect 11 wherein the expanded metal is directional flow expanded metal.

Aspect 20. A variably crimped filter further to aspect 11 wherein the filter has a central cavity.

While there is shown and described herein certain specific structures embodying various embodiments of the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A filter for an airbag inflator comprising a continuous strip of expanded metal rolled-up about a longitudinal axis to form multiple rolled, overlapping layers, the filter having an inner layer and a plurality of outer layers,
wherein each successive layer of the filter is formed by a discrete section of the continuous strip,
wherein the continuous strip is bi-directionally expanded such that at least one section is expanded in a top-down direction providing said section with a smooth side on one surface thereof and at least one section is expanded in a bottom-up direction providing said section with a smooth side on an opposing surface,
thereby creating a rolled filter with at least one layer having a smooth side facing inwardly and at least one layer having a smooth side facing outwardly.

2. The filter of claim 1 wherein the strip of extended metal is flattened.

3. The filter of claim 1 wherein the top-down and bottom up bi-directionally expanded sections are adjacent to each other.

4. The filer of claim 1 wherein each layer of said filter comprises a plurality of apertures having an average open area (OA), and wherein the OA's decrease from the inner layer to at least one of the outer layers.

5. The filter of claim 1 wherein the expanded metal is directional flow expanded metal.

6. The filter of claim 1 wherein at least one of the sections of the continuous strip is crimped to create a plenum layer.

7. The filter of claim 1 wherein the continuous strip comprises alternating crimped and non-crimped layers.

8. The filter of claim 1 wherein the outer layer of the filter is a crimped layer.

9. The filter of claim 1 wherein the inner layer of the filter is a crimped layer.

10. The filter of claim 1 wherein the filter has a central cavity.

11. A filter for an airbag inflator comprising a continuous strip of expanded metal rolled-up about a longitudinal axis to form multiple rolled, overlapping layers, the filter having an inner layer and a plurality of outer layers,
wherein each successive layer of the filter is formed by a discrete section of the continuous strip,
wherein at least one of the sections of the continuous strip is crimped to create a plenum layer.

12. The filter of claim 11 wherein the continuous strip comprises alternating crimped and non-crimped layers.

13. The filter of claim 11 wherein the outer layer of the filter is a crimped layer.

14. The filter of claim 11 wherein the inner layer of the filter is a crimped layer.

15. The filter of claim 11 wherein the continuous strip is bi-directionally expanded such that at least one section is expanded in a top-down direction providing said section with a smooth side on one surface thereof and at least one section is expanded in a bottom-up direction providing said section with a smooth side on an opposing surface,
thereby creating a rolled filter with at least one layer having a smooth side facing inwardly and at least one layer having a smooth side facing outwardly.

16. The filter of claim 11 wherein the strip of extended metal is flattened.

17. The filter of claim 11 wherein the top-down and bottom up bi-directionally expanded sections are adjacent to each other.

18. The filter of claim 11 wherein each layer of said filter comprises a plurality of apertures having an average open area (OA), and wherein the OA's decrease from the inner layer to at least one of the outer layers.

19. The filter of claim 11 wherein the expanded metal is directional flow expanded metal.

20. The filter of claim 11 wherein the filter has a central cavity.
